(19) United States
(12) Patent Application Publication
(10) Pub. No.: US 2016/0265421 A1
(43) Pub. Date: Sep. 15, 2016

(54) TURBOCHARGER SYSTEM

(71) Applicants: Ken CHEN, Taichung City (TW); Fang-Ting LUO, Taichung City (TW)

(72) Inventors: Ken CHEN, Taichung City (TW); Fang-Ting LUO, Taichung City (TW)

(21) Appl. No.: 14/644,210

(22) Filed: Mar. 11, 2015

(51) Int. Cl. F02B 33/40; F01D 25/24; F01D 5/02; F01D 5/12; F02M 35/024; F02M 35/10

(52) U.S. Cl. CPC F02B 33/40; F02M 35/024; F02M 35/10157; F01D 5/02; F01D 5/12; F01D 25/24; F05D 2220/40; F05D 2240/24

(57) ABSTRACT

A turbocharger system includes an intake member, a housing, a rotor, and a cylinder block. The first end edges of blades of the rotor which is used to compress the air are longer than the second end edges of the blades of the rotor, so that the air pressure at the intake end is smaller that air pressure at the discharge end, thus the air is compressed and then supplied to the cylinder block to improve combustion efficiency, which consequently improves power output.

### BACKGROUND OF THE INVENTION

1. Field of the Invention

The present invention relates to a power system of a vehicle, and more particularly to a turbocharger system.

2. Description of the Prior Art

A car possesses a certain power when it was manufactured, and the power of the car comes from the engine. When air is introduced into the combustion chamber where the air is mixed with the fuel and ignited, explosion occurs to push the piston, which consequently produces drive power.

Therefore, the combustion efficiency has a direct influence on the power output. The more complete the combustion is, the greater the amount of the power output will be. The amount of air needed for complete combustion is always larger than the amount of air introduced into the combustion chamber. Hence, a turbocharger system 10 was invented, as shown in FIG. 1, and comprises a cylinder stator 11, an exhaust gas turbine 12, and a compressor turbine 13. The exhaust gas is discharged from an exhaust end 111 of the cylinder stator 11 and introduced into the exhaust gas turbine 12 to cause rotation of the exhaust gas turbine 12, which then causes the rotation of the compressor turbine 13 via a driven shaft 121. Meanwhile, fresh air is sucked into the compressor turbine 13 and compressed therein and finally pushed into the cylinder stator 11 via an air intake end 112, so as to combustion efficiency of the cylinder stator 11.

However, the turbocharger system 10 does not consist of a single turbine and must require an exhaust gas turbine 12 and a driven compressor turbine 13 due to the fact that it has to intake exhaust gas to produce power, and compress fresh air. Therefore, the turbocharger system 10 has a relatively heavy weight and big size, which increases the load of the car.

The turbocharger system 10 has to be connected between the exhaust end 111 and the intake end 112, which not only makes the structure complicated but also increases the manufacturing cost. Besides, installing the turbocharger system 10 requires professional skills and complicated pipelines, which further increases the cost.

The present invention has arisen to mitigate and/or obviate the afore-described disadvantages.

### SUMMARY OF THE INVENTION

The primary objective of the present invention is to provide a turbocharger system which is free of the abovementioned problems of the conventional turbocharger system.

To achieve the above objective, a turbocharger system in accordance with the present invention comprises: an intake member, a housing, a rotor, and a cylinder block. The housing includes an outer peripheral surface and an inner peripheral surface, the outer peripheral surface defines a cylinder whose two ends have equal diameter, and the inner peripheral surface is inclined with respect to the outer peripheral surface so as to define a conical inner space, the inner peripheral surface including a first end and a second end, the first end is in communication with the intake member. The rotor includes a central shaft and a plurality of blades radially extending from the central shaft, the rotor is disposed in the inner space of the housing. Each of the blades includes a front surface, a rear surface, a connecting edge connected to the central shaft, and an outer edge opposite to the connecting edge. The front surface of one blade is located toward the rear surface of a neighboring blade, the connecting edge and the outer edge of each of the blades are connected by a first end edge and a second end edge, the first end edge includes a first length extending between the connecting edge and the outer edge, the second end edge includes a second length extending between the connecting edge and the outer edge, and the first length is larger than the second length. The rotator is disposed in the inner space of the housing in a manner that the first end edge of each of the blades is located toward the first end of the inner peripheral surface, and the second end edge is located toward the second end of the inner peripheral surface of the housing. The cylinder block includes a combustion chamber, an intake end and a discharge end which are in communication with one another, the intake end of the cylinder block is connected to and in communication with the second end of the inner peripheral surface of the housing.

The first end edges of the rotor which is used to compress the air are longer than the second end edges of the rotor, the air pressure at the intake end is smaller that air pressure at the discharge end, so that the air is compressed and then supplied to the cylinder block to improve combustion efficiency.

### BRIEF DESCRIPTION OF THE DRAWINGS

FIG. 1 is a perspective view of a conventional turbocharger system;

FIG. 2 is an exploded view of a turbocharger system in accordance with a preferred embodiment of the present invention;

FIG. 3 is an end view of the rotor of the turbocharger system in accordance with the present invention;

FIG. 4 is another end view of the rotor of the turbocharger system in accordance with the present invention;

FIG. 5 is a cross sectional view of the turbocharger assembly of the turbocharger system in accordance with the present invention; and

FIG. 6 is a systematic view of the turbocharger system in accordance with the present invention.

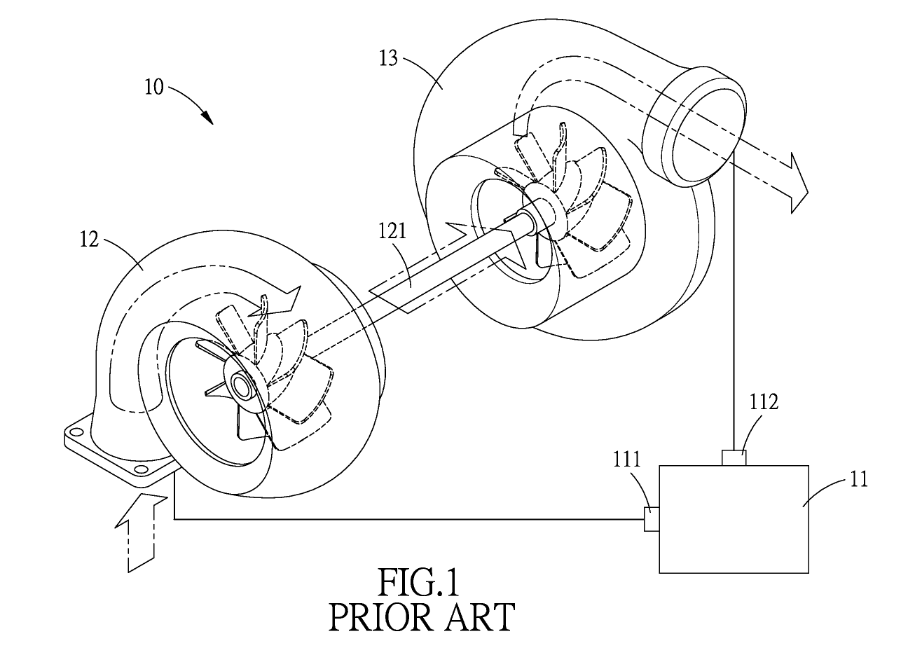

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

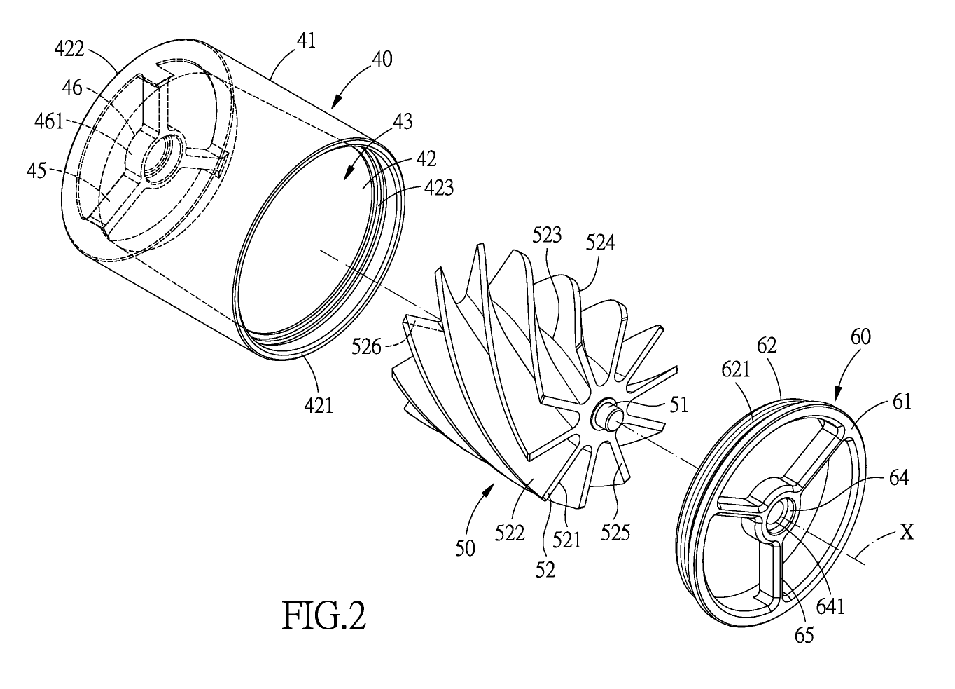

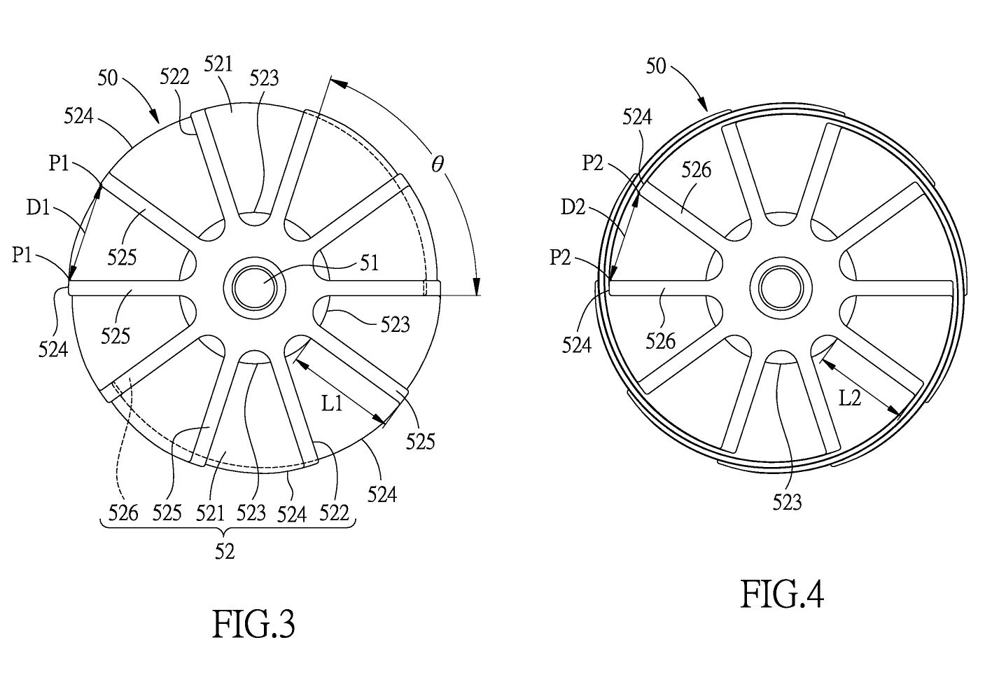

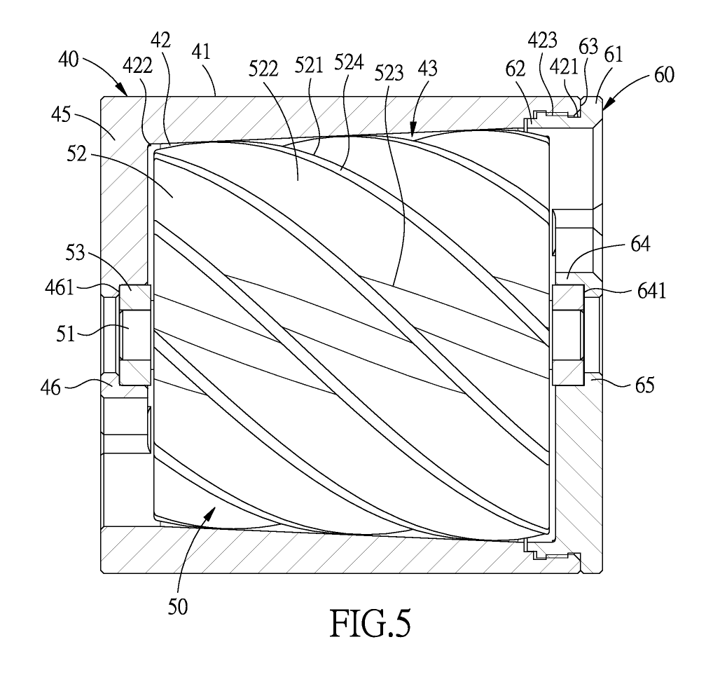

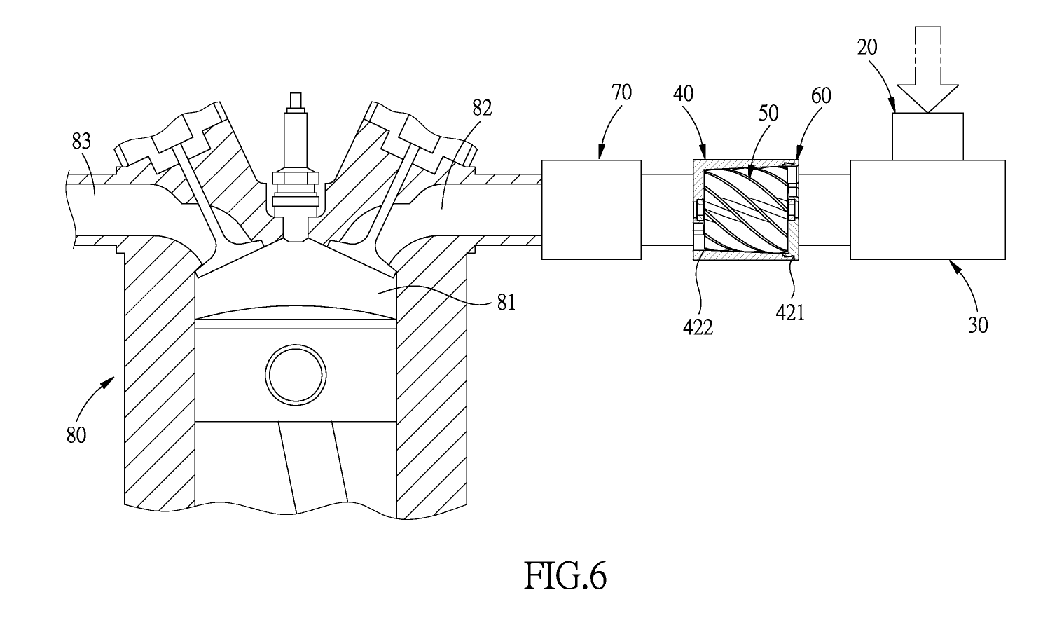

Referring to FIGS. 2-6, a turbocharger system in accordance with a preferred embodiment of the present invention comprises: an intake member 20, an air filter 30 connected to the intake member 20, a turbocharger assembly with one end connected to the air filter 30, a throttle valve 70 and a cylinder block 80.

The turbocharger assembly comprises a housing 40, a rotor 50 and a cover 60.

The housing 40 is a hollow cylindrical structure with one end completely open and another end partially open, and includes an outer peripheral surface 41 and an inner peripheral surface 42. The outer peripheral surface 41 forms a cylinder whose two ends have equal diameter, and the inner peripheral surface 42 is inclined with respect to the outer peripheral surface 41, so that the inner peripheral surface 42 defines a conical inner space 43. The inner peripheral surface 42 includes a first end 421 which is connected to the inner space 43, and a second end 422 at which a plurality of spacer ribs 45 is formed. The inner peripheral surface 42 is formed with an inner thread 423 which is located adjacent to the first end 421. The spacer ribs 45 extend to a bearing seat 46 which is located at the center of the inner peripheral surface 42. One surface of the bearing seat 46 located toward the inner space 43 is formed with a cavity 461. The second end 422 of the inner peripheral surface 42 of the housing 40 becomes partially open because of the arrangement of the spacer ribs 45. The first end 421 of the housing 40 is connected to the air filter 30 and thus in communication with the intake member 20.

The rotor 50 includes a central shaft 51 and a plurality of blades 52 radially extending from the central shaft 51. The central shaft 51 has two ends inserted in a bearing 53, respectively. The rotor 50 is disposed in the inner space 43 of the housing 40 and has one of the bearings 53 disposed in the cavity 641. Each of the blades 52 has a front surface 521, a rear surface 522, a connecting edge 523 connected to the central shaft 51, and an outer edge 524 opposite to the connecting edge 523. The front surface 521 of one blade 52 is located toward the rear surface 522 of a neighboring blade 52. The connecting edge 523 and the outer edge 524 of each of the blades 52 are connected by a first end edge 525 and a second end edge 526. The first end edge 525 has a first length L1 extending between the connecting edge 523 and the outer edge 524, the second end edge 526 has a second length L2 extending between the connecting edge 523 and the outer edge 524, and the first length L1 is larger than the second length L2. The first end edge 525 has a first outer end P1 at which the first end edge 525 and the outer edge 524 are connected, and the second end edge 526 has a second outer end P2 at which the second end edge 526 and the outer edge 524 are connected. A distance between the first outer ends P1 of two neighboring blades 52 is defined a first distance D1, a distance between the second outer ends P2 of two neighboring blades 52 is defined as a second distance D2, and D1 is larger than D2.

A view looking from both ends of the rotor 50 shows that there is a twist angle θ between the first and second end edges 525, 526 of each of the blades 52, and the twist angle θ is 10-180 degrees. In this embodiment, the twist angle θ is 75 degrees, and can also be 45, 60, 90, 110, 130, 145 or 160 degrees. The outer edge 524 is arc-shaped with respect to an axial direction X of the central shaft 51.

The rotor 50 is disposed in the inner space 43 of the housing 40 in such a manner that the first end edge 525 of each of the blades 52 is located toward the first end 421 of the inner peripheral surface 42, and the second end edge 526 is located toward the second end 422 of the inner peripheral surface 42 of the housing 40.

The cover 60 is an annular hollow structure and includes an abutting section 61, a mounting section 62 connected to the abutting section 61, and a shoulder portion 63 formed at the connection between the mounting and abutting sections 62, 61. The mounting section 62 includes an outer thread 621. The abutting section 61 has an outer diameter larger than that of the mounting section 62. At the center of the cover 60 is formed a bearing seat 64, and a plurality of stop ribs 65 extends from the inner peripheral edge to the bearing seat 64. On the bearing seat 64 is formed a cavity 641. In this embodiment, there are three equiangularly spaced stop ribs 65. The mounting section 62 is inserted in the first end 41 of the housing 40, the outer thread 621 of the cover 60 is meshed with the inner thread 423 of the housing 40, the shoulder portion 63 of the abutting section 61 is abutted against the housing 40, and another of the bearings 53 of the rotor 50 is disposed in the cavity 641 of the cover 60. The first end edges 525 of the rotor 50 of the turbocharger assembly are connected to the air filter 30.

The throttle valve 70 is connected to another end of the turbocharger assembly, and more particularly to the second end edges of 526 of the rotor 50.

The cylinder block 80 includes a combustion chamber 81, an intake end 82 and a discharge end 83 which are in communication with one another. The intake end 82 of the cylinder block 80 is connected to and in communication with the throttle valve 70.

Air is fed through the intake member 20 and filtered by the air filter 30 and then pushed into the turbocharger assembly, in such a manner that the air is introduced through the first end edges 525 of the rotor 50 into the housing 40 and flows through the blades 52 to push the rotor 50 to rotate. The air flows from the first end edges 525 of the rotor 50 toward the second end edges 526 along the blades 52. Since L1>L2, and D1>D2, the space between the first end edges 525 when the air is fed into the rotor 50 is larger than the space between the second end edges 526 when the air is discharged from the rotor 50, namely, the air pressure between the first end edges 525 of the rotor 50 is smaller than the air pressure between the second end edges 526, so that air is compressed by the rotor and pushed into the cylinder block 80 via the throttle valve 70, so as to improve combustion efficiency of the cylinder block 80 and increase power output.

On the other hand, the turbocharger assembly of the present invention is simply structured and has a small size, and can be easily installed by being connected between the intake member 20 and the cylinder block 80 without requiring the use of complicated pipeline or profession skill. Moreover, the rotor 50 of the present invention is disposed in the housing 40, and the outer peripheral surface 41 forms a cylinder whose two ends have equal diameter, which makes it easier for the user to install the turbocharger assembly. The inner peripheral surface 42 of the housing 40 is inclined to fit the shape of the rotor 50, so as to improve the air compression effect. The outer edge 524 of the respective blades 52 of the rotor 50 is arc-shaped, and a twist angle θ is defined between the first and second end edges 525, 526 of each of the blades 52, so that air can flow more smooth when pushing the blades 52 to rotate the rotor 50, which further improves the air compression efficiency.

With the simply structured turbocharger assembly disposed between the cylinder block 80 and the intake member 20, compressed air can be supplied to the cylinder block 80 to increase power output. Therefore, the turbocharger of the present invention not only can be assembled easily with less manufacturing cost, but also can effectively increase power output.

While we have shown and described various embodiments in accordance with the present invention, it is clear to those skilled in the art that further embodiments may be made without departing from the scope of the present invention.

What is claimed is:

1. A turbocharger system comprising:
an intake member;
a housing with an outer peripheral surface and an inner peripheral surface, the outer peripheral surface defining a cylinder whose two ends have equal diameter, and the inner peripheral surface being inclined with respect to the outer peripheral surface so as to define a conical inner space, the inner peripheral surface including a first end and a second end, the first end being in communication with the intake member;
a rotor including a central shaft and a plurality of blades radially extending from the central shaft, the rotor being disposed in the inner space of the housing, each of the blades including a front surface, a rear surface, a connecting edge connected to the central shaft, and an outer edge opposite to the connecting edge, the front surface of one blade being located toward the rear surface of a neighboring blade, the connecting edge and the outer edge of each of the blades being connected by a first end edge and a second end edge, the first end edge including a first length extending between the connecting edge and the outer edge, the second end edge including a second length extending between the connecting edge and the outer edge, and the first length is larger than the second length, the rotor being disposed in the inner space of the housing in a manner that the first end edge of each of the blades is located toward the first end of the inner peripheral surface, and the second end edge is located toward the second end of the inner peripheral surface of the housing; and
a cylinder block including a combustion chamber, an intake end and a discharge end which are in communication with one another, the intake end of the cylinder block being connected to and in communication with the second end of the inner peripheral surface of the housing.

2. The turbocharger system as claimed in claim 1, wherein a twist angle is defined between the first and second end edges of each of the blades when viewing from both ends of the rotor, and the twist angle is 10-180 degrees.

3. The turbocharger system as claimed in claim 2, wherein the twist angle is 75 degrees.

4. The turbocharger system as claimed in claim 1, wherein the outer edge of each of the blades is arc-shaped with respect to an axial direction of the central shaft.

5. The turbocharger system as claimed in claim 1, wherein the first end edge of each of the blades has a first outer end at which the first end edge and the outer edge are connected, and the second end edge of each of the blades has a second outer end at which the second end edge and the outer edge are connected, a distance between the first outer ends of two neighboring blades is defined a first distance, a distance between the second outer ends of two neighboring blades is defined as a second distance, and the first distance is larger than the second distance.

6. The turbocharger system as claimed in claim 1, wherein the first end of the inner peripheral surface of the housing is fully in communication with the inner space, the inner peripheral surface is formed with an inner thread which is located adjacent to the first end, a plurality of spacer ribs is formed at the second end of the inner peripheral surface of the housing to make the second end of the inner peripheral surface of the housing partially open, a cover is disposed at the firs tend of the housing, and the cover is an annular hollow structure with an outer thread to mesh with the inner thread of the housing.

7. The turbocharger system as claimed in claim 6, wherein the cover includes an abutting section, a mounting section connected to the abutting section, and a shoulder portion formed at the connection between the mounting and abutting sections, the outer thread is formed on the mounting section, the abutting section has an outer diameter larger than that of the mounting section, and the shoulder portion of the abutting section is abutted against the housing.

8. The turbocharger system as claimed in claim 1, wherein the central shaft of the rotor has two ends inserted in a bearing, respectively, the spacer ribs of the housing extend to a bearing seat, a plurality of stop ribs of a cover extend to another bearing seat, one surface of the bearing seat of the housing located toward the inner space is formed with a cavity, one surface of the bearing seat of the cover located toward the inner space is formed with another cavity, the bearings at two ends of the rotor are disposed at the cavities, respectively.

9. The turbocharger system as claimed in claim 1, wherein an air filter is disposed between the intake member and the housing.

10. The turbocharger system as claimed in claim 1, wherein a throttle valve is disposed between the housing and the cylinder block.
